(19) United States
(12) Patent Application Publication
(10) Pub. No.: US 2008/0044633 A1
(43) Pub. Date: Feb. 21, 2008

(54) Printing Quality Improvement of Pigmented Inks on Glossy Media

(76) Inventors: Yaqiang Frank Ming, Lexington, KY (US); Rebecca Silveston-Keith, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 11/428,067

(22) Filed: Jun. 30, 2006

(51) Int. Cl. B41J 2/01; B32B 7/14

(52) U.S. Cl. 428/201; 347/1

(57) ABSTRACT

The present invention relates to a method and materials that improve the printing properties of pigmented inks on glossy media, especially smear resistance, gloss, and differential gloss. The method is to apply a very uniform thin coating based on low molecular weight water-soluble polymers such as polyvinyl alcohol and acrylic resins and medium-high molecular weight polymer emulsion/dispersion on printed images. The polymers have good film formation and mechanical/physical properties. They also preferably have good jettability, either by thermal or piezo methods. The thin coating is preferably applied by jetting process through one of chambers of the ink cartridges, but can be applied by other processes such as Meyer rod, roll coater, etc.

### TECHNICAL FIELD

The present invention relates to a method and materials t hat improve the printing properties of pigmented inks on glossy media, especially smear resistance and different gloss.

### BACKGROUND OF THE INVENTION

Ink jet printing is a non-impact method of printing that involves ejecting ink from a nozzle onto paper or other print media. The actual ink ejection method may occur via several processes including pressurized nozzles, electrostatic fields, piezoelectric elements within an ink nozzle, and heaters for vapor phase bubble formation.

The composition of the ink is traditionally comprised of deionized water, a water soluble organic solvent, and a colorant. The colorant may be a soluble dye or insoluble pigment. Several problems, however, are associated with soluble dyes that are not applicable to insoluble pigments. These problems include poor water-fastness, poor light-fastness, poor thermal stability, facile oxidation, dye crystallization, and ink bleeding and feathering on the print medium. To circumvent these problems, use of a pigment as the colorant is preferred. Pigments generally have better light-fast and water-fast properties, are more resistant to oxidation, and have higher thermal stability.

Use of a pigment instead of an aqueous dye presents solubility problems since the pigments are insoluble in aqueous media. As a result, the insoluble pigment is generally stabilized in a dispersion by a polymeric dispersant.

Smear resistance and differential gloss on photo paper, especially on gelatin paper, is a significant problem for pigment-based inks. Most gelatin paper is designed for use with dye-based inks. When a pigment-based ink is printed onto a gelatin photo paper, the solvents will penetrate into the paper and later evaporate into the environment. Pigment and the polymeric dispersant will loosely pack on the paper surface. The packed pigment-dispersant cake has only a weak adhesion on the paper surface, and weak smear resistance has often been observed. The poor differential gloss is due to the interaction of different inks and amount of inks laid on the media. For example, the composite black area is duller and typically has lower gloss than single color area.

By changing ink or photo paper formulation, many methods have been disclosed in the past to improve smear resistance. For example, US 20040102541 disclosed graft polymeric dispersants in pigment-based inks to increase smear resistance; US 20050166794 disclosed using a dispersed cellulose ester as a binder additive in pigment-based inks to enhance the durability of the printed images; US 20050134665 disclosed ink additives that contains benzyl methacrylate to increase smear resistance. US 20050110856, U.S. Pat. No. 6,020,397, and U.S. Pat. No. 6,503,307 disclosed some imaging fixing components (reactive liquids) to improve abrasion resistance. One the other hand, U.S. Pat. Nos. 6,844,035, 6,689,433, and 6,528,148 disclosed the use of a poly(vinyl alcohol polyethylene oxide) copolymer and other binders in polymer-based photo papers to improve smear-fastness. U.S. Pat. No. 6,626,531 disclosed the surface roughness from 0.2 to 2.0 μm to improve smear for pigment-based ink on a porous media.

Some studies to improve th gloss especially differential gloss have also been disclosed. For example, Epson presented an article including a deposition method that deposits a clear ink on low print duty areas (NIP19, p237-240, 2003). The problem of the method is some heavier ink area has no clear ink, which as very poor smear. Different surfactants such as Dynol 604 have been optimized to improve gloss (Shawn Cai, etc.). The draw back for this method is potential stability issues and poor smear.

It is an objective of this invention to provide a method and materials that improve the printing properties of pigmented inks on glossy media, especially smear resistance and good differential gloss.

### SUMMARY OF THE INVENTION

The present invention provides ink receiving print media products capable of improving smear for pigmented inks. In particular, a method and materials are disclosed that improve the printing properties of pigmented inks on glossy media, especially smear resistance and differential gloss. The method is to apply a very uniform thin coating based on low molecular weight water-soluble polymers such as a polyvinyl alcohol and an acrylate polymer and medium/high molecular weight polymer emulsion/dispersion such as acrylate latex and polyurethane dispersion on printed images. The water soluble polymers or polymer dispersions have good film formation and mechanical/physical properties. They also preferably have good jettability, either by thermal or piezo methods. The thin coating is preferably applied by jetting process through one of chamber of the ink cartridges, but can be applied by other processes such as Meyer rod, roll coater, etc.

In a preferred embodiment, the substrate of the print media product is a polymer-based photo paper. The thickness of the uniform thin coating applied on to the printed images is from about 0.1 μm to about 20 μm.

All percentages and ratios, used here, are “by weight” unless otherwise specified. All molecular weights, used herein, are weight average molecular weights unless otherwise specified. Further details and advantages of the present invention are set forth below in the following more detailed description.

### DETAILED DESCRIPTION OF THE INVENTION

The present invention provides ink receiving print media products capable of improving smear for pigmented inks. In particular, a method and materials are disclosed that improved the printing properties of pigmented inks on glossy media, especially smear resistance and differential gloss. The method is to apply a very uniform thin coating comprising an ingredient selected from the group consisting of low molecular weight water-soluble polymers such as a polyvinyl alcohol and/or an acrylate polymer, medium/high molecular weight polymer emulsion and/or dispersion such as acrylate latex and polyurethane dispersion, and mixtures thereof on printed images. The water soluble polymers or polymer dispersion have good film formation and mechanical/physical properties. They also preferably have good jettability, either by thermal or piezo methods. The ink coating is preferably applied by jetting process through one of chambers of the ink cartridges, but can be applied by other processes such as Meyer rod, roll coater, etc.

The print media employed may be any print media compatible with aqueous-based inks, including plain papers, such as commercial bond papers; coated papers (or special inkjet papers), such as those available from Hewlett Packard, Kodak, Ilford, Canon, and Xerox Corporation; textiles, special inkjet Papers, including silica coated papers and photorealistic inkjet papers; photographic papers, and inkjet transparency materials suitable for aqueous inks or inkjet printing processes.

In a preferred embodiment, the substrate of he print media product is a polymer-based photo paper. The thickness of the uniform thin coating applied on to the printed images is from about 0.1 μm to about 20 μm.

Smear resistance on photo paper, especially on gelatin paper, is a significant problem for pigmented inks comprising a pigment dispersion. Most gelatin paper is designed for use with dye based inks. When conventional pigmented inks are printed on gelatin based paper, the pigmented dispersion remains on the surface of the gelatin coating and is susceptible to smearing or smudging.

Low molecular weigh water-soluble polymers: The first type of low molecular weight water-soluble polymer that is applied on to the printed images is comprised of a water soluble acrylate polymers. A preferred acrylate polymers includes water solubilized copolymers of styrene, alpha methylstyrene, and acrylic acid. The copoloymers can be made by standard synthetic techniques such as those described in Odian's Principles of Polymerization, 3^{rd} Edition, John Wiley and Sons, Inc. (1991). The polymers are preferred to be made by free radical polymerization. The polymers can have a hydrophilic polymeric segment, a hydrophobic segment, and a stabilizing segment. The hydrophilic segment is responsible for controlling the water solubility of the polymer, which is made from acrylic acid, etc.

Water soluble or dispersible acrylics can also be obtained from S.C. Johnson & Co. in Racine, Wis., which sells the acrylics under the name of JONCRYL™. Preferred examples of Joncryl acrylics are the Joncryl 555, 586, 671, 678, 680, 682, 683, and 67, which are water solubilized copolymers of styrene, alpha methylstyrene, and acrylic acid. Other preferred examples include the styrene-acrylic acid copolymers, Joncryl 538 and 138. Joncryl 678, one of the more preferred acrylic resins, has a glass transition temperature of 85° C., an acid number of 215, a weight average molecular weight of 8500, and a softening point of 165° C.

The second type of low molecular weight water-soluble polymer applied on to the printed images is comprised of polyvinyl alcohol (PVA). Polyvinyl alcohol as used herein includes partially, intermediately, and fully hydrolyzed. It also includes cationic, anionic, and silanol, polyethylene oxide modified, etc. PVA can have arrange of molecular weight from low to medium to high. The low molecular weight and partially hydrolyzed form is preferred, such as Mowiol 3-83. The basic structural formula for polyvinyl alcohol is as follows: (—CH₂CHOH—)ₓ wherein x=about 1-3000 in a representative, non-limiting, and preferred embodiment.

This material is commercially available from numerous sources including but not limited ti Nippon Gohsei of Osaka, Japan under the product designation “GOHSENOL”, Dupont under the product designation “Elvanol”, as well as Clariant under the product designation of “Mowiol”. Exemplary and non-limiting derivatives of polyvinyl alcohol which shall be encompassed within the term “polyvinyl alcohol” as used herein include but are not limited to unsubstituted polyvinyl alcohol as illustrated and discussed above, carboyxlated polyvinyl alcohol, sulfonated polyvinyl alcohol, acetoacetylated polyvinyl alcohol, and mixtures thereof.

However, regarding the use of polyvinyl alcohol in the coatings of the present invention, “straight” (e.g. unsubstituted) polyvinyl alcohol is preferred. Likewise, use of the term “polyvinyl alcohol” as stated herein shall encompass polyvinyl alcohols which are “fully hydrolyzed” or “partially hydrolyzed”. During the producing process associated with polyvinyl alcohol varying degrees of “hydrolysis” can occur whereby, in certain situations, residual acetate groups (—OCOCH₃) are left within the polyvinyl alcohol backbone depending on a wide variety of production and reaction parameters. For example, a polyvinyl alcohol molecule is traditionally considered to be “fully hydrolyzed” if less than about 1.5 mole percent acetate groups are left on the molecule. This characterization is discussed in, for instance, U.S. Pat. No. 5,880,196.

In addition, “polyvinyl alcohol” shall also be defined and interpreted herein to encompass structures wherein the polyvinyl alcohol competent thereof is considered to be “partially hydrolyzed”. Partially hydrolyzed polyvinyl alcohol is typically defined to involved polyvinyl alcohol molecules wherein about 1.5 to as much as about 20 mole percent or more acetate groups are left on the molecule. Again, the extend of hydrolysis will depend on a wide variety of product parameters. It has been determined that, while any of the aforementioned polyvinyl alcohol compositions within the foregoing broad definition can be used as a first polymer, polyvinyl alcohols having a hydrolysis level of about 80-98% will provide effective results.

Other type of low molecular weight water-soluble acrylate dispersants, PVP, etc can also be used.

The first and second type of low molecular weight water-soluble polymers (i.e., acrylate polymer and polyvinyl alcohol) can be used alone or as a blend.

The medium/high molecular weight acrylate polymer emulsion/dispersion is applied as an over coating on printed images. A preferred acrylate polymer includes styrene acrylate with acid functional group containing diene monomer. The polymer is typically made by emulsion polymerization and has high molecular weight.

The preparation of styrene acrylate binder is well know to those skilled in the art. For example, the preparation of emulsion polymers is described in Emulsion Polymerization by Gilbert, R. G., Academic Press, N.Y., 1995, incorporated by reference herein. They can be made by a continuous process as described in U.S. Pat. Nos. 4,546,160, 4,414,370, and 4,529,787 all of which are incorporate by reference herein. They can also be made as resin-supported emulsions prepared by aqueous phase polymerization in the presence of water-dispersible support resins as described in U.S. Pat. Nos. 4,894,397, 4,839,413, and 4,820,762 all of which are incorporate by reference herein. Generally such polymers are prepared with ethylenically unsaturated monomers, initiators, and optionally with surfactants, alkali, an water or another reaction solvent. Exemplary monomers include, but are not limited to, acrylic acid, methacrylic acid, styrene, methyl styrene, butyl acrylate, ethyl methyacrylate, 2-ethyl hexyl acrylate, methyl methacrylate etc. Those skilled in the art will readily appreciate that the mixture of monomers may be varied as necessary to tailor the polymer to the particular application. For example, the polymer can have a wide range of acid numbers from 20 to 350. The polymer also can have wide range of glass transition temperature from −30 to 150° C.

In a preferred embodiment, the styrene acrylate polymer is an emulsion and has a number molecular weight above 20,000, an acid number of form about 20 to about 350, and a Tg of from about −30° C. to 150° C. In one embodiment of the present invention, a specific acrylic-based polymer emulsion, Joncryl 660 Film Form Emulsion from Johnson Polymer (Sturtevant, Wis.), was used over coating. Some physical properties of Joncryl 660 are listed in Table 1 below.

TABLE 1

| | |
|---|---|
| pH | 8.5 |
| Non-Volatile | 32% |
| MW | >200,000 |
| Viscosity | 400 cps |
| Tg | 27° C. |
| Acid Number | 203 (NV) |

Typical Physical Properties of Joncryl 660

The medium/high molecular weight polyurethane dispersion is applied as an over coating on printed images. Examples of suitable commercially available polyurethane dispersions include Bayhydrol from Bayer, Witcobond from Crompton, and HD series from Hauthaway.

Other types of polymer emissions and dispersions such as epoxy etc. can also be used over coating.

A blend of the above described acrylate emulsion, polyurethane dispersion, and other type of emulsion/dispersion can also be used.

A blend of low molecular weight water soluble polymers and polymer emulsion or dispersion can also be used.

Other additives known in the art can be added optionally, including: any surfactants for wetting, defoamers, biocides, hardeners, crosslinker, pigment, thickeners, UV/light stabilizers, buffers, slip agents, pH control compounds, and mixtures thereof.

The coating method used to apply the coating formulation on the printed images may be any appropriate manufacturing procedures including, without limitation, jetting, roll-coating, spray-coating, immersion, cast-coating, slot-die coating, curtain coating, rod-coating, blade-coating, roller application, and other related production methods. The preferred method is jetting.

Any drying method in the art such as convection flow, IR etc may be optionally used to dry the coatings. The preferred method is “drying” by media absorption.

It is also observed that the thickness of the thin coating affects the smear resistance or pigment-based ink on such a glossy printing medium. Only within a proper range of coasting thickness (about 0.1-20 μm), can both short-term and long-term smear resistance of pigment-based ink be greatly improved. When the coating thickness is less than 0.1 μm, it is observed that the coating layer cannot provide coverage and good film and the ink smear resistance is low. On the other hand, when the coating thickness is more them 20 μm, the substance has poor capacity and ink may not be dried and smear and gloss are poor.

As discussed above, the thin coating acts to improve the smear resistance, gloss, and differential gloss of a pigment-based ink composition that is printed on the ink glossy printing medium. Suitable pigment-based inkjet compositions for printing on to the print media products of the present invention comprise and insoluble pigment, a dispersant and an aqueous carrier. The pigment-based inkjet composition comprise from about 0.1% to about 10%, more preferably from about 2% to about 6% of an insoluble pigment, from about 0.1% to about 10% of a dispersant, and an aqueous carrier.

A wide variety of organic and inorganic pigments, alone or in combination, may be selected for use in the aqueous inks. The key selection criterion foe a pigment is that it must be dispersible in the aqueous medium with the aid of dispersants. The term “pigment”, as herein, means an insoluble colorant (including organic and inorganic pigments). The selected pigment may be used in dry or wet form.

Suitable pigments include organic and inorganic pigments of a particle size sufficient to permit free flow of the ink through the ink jet printing device, especially at the ejecting nozzles that usually have a diameter from about 10 microns to 50 microns. Thus, a suitable pigment particle size is from about 0.05 to about 15, preferably from about 0.05 to about 5, and more preferably from about 0.05 to about 0.5 microns. Pigments suitable for use in the pigment invention include azo lakes, insoluble azo pigments condensed azo pigments and chelate azo pigments, polycyclic pigments. perylene pigments, anthraquinone pigments, quinacridone pigments, dioxazine pigments, thiondigo pigments, isoindolinone pigments, quinophthalone pigments, and dry lakes. Suitable organic pigments include nitro pigments, nitroso pigments, aniline black and daylight fluorescent pigments. Preferred pigments include carbon black, Pigment Red 122, Pigment Red 202, Pigment Yellow 74, Pigment Yellow 128, Pigment Yellow 138, Pigment Yellow 155, Pigment Blue 15:3 and Pigment Blue 15:4.

The second component of the aqueous ink compositions is the dispersant. Dispersants useful in the aqueous ink compositions are generally not limited and include any of those capable of dispersing pigments. The dispersants typically comprise hydrophobic and hydrophilic polymeric segments. The hydrophobic segment tens to interacts with the pigment particle in the ink compositions and the hydrophilic segment tends to be solvated by the aqueous medium thereby dispersing the pigment.

Illustrative examples of the dispersants which may be employed in the ink compositions include AB, BAB and ABC block copolymers known in the at. Preferred AB and BAB block copolymers include those, for example, which comprise hydrophobic and hydrophilic segments derived from acrylic monomers. Another illustrative example of dispersants includes random copolymers.

A preferred class of dispersants which may be employed in the ink compositions described herein include block and or graft co- or terpolymers comprising a hydrophilic polymeric segment, and one or two hydrophobic polymeric segment(s) having a hydrolytically stable siloxyl substituent or a hydrophobic amide side chain. A particularly preferred subgroup of these dispersants are graft terpolymers which comprise a hydrophilic polymeric segment (particularly an acrylic or methacrylic acid co- or terpolymer) together with a hydrophobic polymeric segment derived from a polyorganosiloxane as described in U.S. Pat. Nos. 5,719,204 and 5,714,538.

The third component of he aqueous ink compositions is the aqueous carrier medium which is generally present at from about 70% to about 99% of the composition. The aqueous carrier medium comprises water (preferably deionized water) and, preferably, at least one water soluble organic solvent. Selection of a suitable carrier mixture depends on the requirements of the specific application involved, such as desired surface tension and viscosity, the selected pigment, the desired drying time of the ink, and the type of paper onto which the ink will be printed. Representative examples of water soluble organic solvents that may be selected include (1) alcohols, such as methyl alcohol, ethyl alcohol, n-propyl alcohol, isopropyl alcohol, n-butyl alcohol, sec-butyl alcohol, t-butyl alcohol, iso-butyl alcohol, furfuryl alcohol, and tetrahydrofurfuryl alcohol; (2) ketones or ketoalcohols, such as acetone, methyl ethyl ketone and diacetone alcohol; (3) ethers, such as tetrahydrofuran and dioxane; (4) esters, such as ethyl acetate, ethyl lactate, ethylene carbonate and propylene carbonate; (5) polyhydric alcohols, such as ethylene glycol, diethylene glycol, triethylene glycol propylene glycol, tetraethylene glycol, polyethlene glycol, glycerol, 2-methyl-2,4-pentanediol, 1,2,6-hexanetriol and thiodiglycol; (6) lower alkyl mono- or di-ethers derived from alkylene glycols, such as ethylene glycol monomethyl (or monoethyl) ether, diethylene glycol monomethyl (or monoethyl) either, propylene glycol monomethyl (or monoethyl) ether, triethylene glycol monomethyl (or monoethyl) ether and diethylene glycol dimethyl (or diethyl) ether; (7) nitrogen-containing cyclic compounds, such as pyrrolidone, N-methyl-2-pyrrolidone, and 1,3-dimethyl-2-imidazoli-dinone; and (8) sulfur-containing compounds, such as dimethyl sulfoxide and tetramethylene sulfone. Other useful organic solvents include lactones and lactams. Mixtures of these solvents may be used in the ink compositions.

The aqueous ink compositions may further comprise a humectant mixture. Preferred humectants include, but are not limited to, bis-hydroxy terminated thioethers, lactams, and polyalkylene glycols. The amount of humectant in an ink formulation can range from 0 to 40 weight percent, preferably from 15 to 25 weight percent.

The ink compositions may further comprise surfactants to modify the surface tension of the ink and to control the penetration of the ink into the paper. Such surfactants are included in the ink compositions, and are not a component of the dispersant. Suitable surfactants include, but are not limited to, nonionic, amphoteric and ionic surfactants. Preferred surfactants include, but are not limited to, alkyl sulfate, nonyl phenyl polyethylene glycol, SILWET™ (OSI Sealants, Inc.), TERGITOL™ (Union Carbide( and SURFYNOL™ (Air Products and Chemicals) Inc.).

The ink composition may also comprise a binder. The binder included in the ink compositions of the present invention is generally not limited so long as the binder has an ability to form a film. Typically the binder comprises an emulsion of acrylic resin, methacrylic resin, styrene resin, urethane resin, acrylamide resin, epoxy resin, or a mixture of these resins. The resin is not limited by copolymerization methods and may be, for example, a block copolymer, or random copolymer or the like.

In one embodiment, the binder comprises a latex polymer comprising the monomer units methyl methacrylate, butylacrylate, and methacrylic acid. In another embodiment, the binder comprises a latex polymer comprising the monomer units methyl methacrylate, butylacrylate, 2-hydroxyethyl; methacrylate, and methacrylic acid. In another embodiment, the binder comprises a latex polymer comprising the monomer units methyl methacrylate, butyl acrylate, N-hydroxymethyl methacrylamide, and methacrylic acid. In another embodiment, the binder has a molecular weight between 150,000 and 300,000.

The amount of binder used in the inks is limited by the binder's compatibility with the other components of the ink composition and its ability to reduce smearing of the ink. In an embodiment, the amount of binder included in the ink composition may range from about 1.0 to about 10% by weight. In another embodiment, the amount of binder in the ink composition ranges from about 1 to about 5% by weight.

Other additives, such as biocides, viscosity modifiers, penetrates, anti-kogation agents, anti-curing agents, chelating agents, anti-bleed agents, binders and buffers may be added to the ink composition at their art established levels. A preferred biocide includes, but is not limited to, Proxel™ GXL (Zeneca).

Application of the inkjet inks described above onto the print media products of the present invention can be made by any suitable printing process compatible with the aqueous-based inks, such as flexographic printing, pen plotters, continuous stream inkjet printing, drop-on-demand inkjet printing (including piezoelectric, acoustic, and thermal inkjet processes), or the like. The inkjet ink compositions are extremely useful in the thermal inkjet printing process. The print media employed may be any print media compatible with aqueous-based inks, including plain papers, such as commercial bond papers; coated papers (or special inkjet papers), such as those available from Hewlett Packard, Kodak, Ilford, Canon, and Xerox Corporation; textiles; special inkjet papers, including silica coated papers and photorealistic inkjet papers; photographic papers; and inkjet transparency materials suitable for aqueous inks or inkjet printing processes.

### EXAMPLES

The following examples are detailed descriptions of methods of preparation and use of the print media products of the present invention. The detailed descriptions fall within the scope of, and serve to exemplify, the more general description set forth above. The examples are presented by illustrative purposes only, and are not intended as a restriction on the scope of the invention.

Table 2 below shows the colorless inks and coating formulations that are used to illustrate the current invention. FM01-06 and FM02-06 are colorless inks based on Mowiol 3-83 and Joncryl 678, respectively. Other dispersants, low molecular weight water-soluble polymers, and medium/high molecular weight polymer emulsion/dispersion can also be used. FM32-02 and FM32-03 are coating formulations based on Mowiol 3-83 and Joncryl 678, respectively.

TABLE 2

| | Formulation | | | |
|---|---|---|---|---|
| | FM32-02 % | FM32-03 | FM01-06 | FM02-06 |
| Mowiol 3-83 (8%) | 55.31 | | 50 | |
| Joncryl 678 (16.4%) | | 30.35 | | 30.3 |
| DI Water | 44.19 | 69.15 | 34.3 | 54 |
| Surfactant 10G | 0.50 | 0.50 | | |
| 1,5-Pentanediol | | | 6.25 | 6.25 |
| 2-P | | | 6.25 | 6.25 |
| Proxel GXL | | | 0.2 | 0.2 |
| 1,2-Hexanediol | | | 3 | 3 |
| pH | | | 7 | 8.7 |
| Viscosity (cps) | | | 5.2 | 2.7 |
| Surface Tension | | | 45 | 43 |
| (dyne/cm) | | | | |

### Colorless Ink and Coating Formulations

### Smear Improvement

### Comparative Example 1

A standard smear test file is printed on a development (DN3) paper with Husky printer and YOC/YOP IH ink sets. The printing mode is Photo/Glossy, 4800 dpi. Five minutes after printing, the sample is tested for smear. The smear is very bad.

### Example 1

A standard smear test file is printed on DN3 paper with Husky printer and YOC/YOP IH ink sets. The printing mode is Photo/Glossy, 4800 dpi, immediately after printing, the sheet is reprinted with a P-6250 printer, all chambers of color and photo cartridges filled with FM02-06 (5% Joncryl 678) colorless ink. The print file is a solid block of black. Five minutes after printing, the printed sample is tested for smear. The test shows improved smear.

### Example 2

A standard smear test file is printed on DN3 paper with Husky printer and YOC/YOP IH ink sets. The printing mode is Photo/Glossy, 4800 dpi. Immediately after printing, the sheet is printed with a P-6250 printer, all chambers of color and photo cartridges filled with FM01-06 (4% Mowiol 3-83) colorless ink. The print file is a solid block of black. Five minutes after printing, the printed sample is tested for smear. The test shows improved smear.

### Example 3

A standard smear test file is printed on DN3 paper with a Husky printer, YOC/YOP IH ink sets, and a special color table. The YOP IH cartridge's K chamber is filled with FM02-06 (5% Joncryl 678). The color table has K all on during printing. The printing mode is Photo/Glossy, 4800 dpi, six color printing. Five minutes after printing, the smear is tested. The smear has improved.

### Example 4

A standard smear test file is printed on DN3 paper with a Husky printer, YOC/YOP IH ink sets, and a special color table. The YOP IH cartridge's K chamber is filled with FM02-06 (5% Joncryl 678). The color table has K all on and diluted c and m off during printing. The printing mode is Photo/Glossy, 4800 dpi, four color printing. Five minutes after printing, the smear is tested. The smear has improved.

### Example 5

A standard smear test file is printed on DN3 paper with Husky printer and YOC/YOP IH ink sets. The printing mode is Photo/Glossy, 4800 dpi. Immediately after printing, the sheet is coated with FM32-03 (5% Joncryl 678) with a #7 rod. Five minutes after coating, the printed sample is tested from smear. The smear has improved dramatically like in Example 1.

### Example 6

A standard smear test file is printed on DN3 paper with Husky printer and YOC/YOP IH ink sets. The printing mode is Photo/Glossy, 4800 dpi. Immediately after printing, the sheet is coated with FM32-02 (5% Mowiol 3-83) with a #7 rod. Five minutes after coating, the printed sample is tested for smear. The smear has improved dramatically like Example 2.

### Gloss and Differential Gloss Improvement

### Comparative Example 2

A standard gloss test file is printed on DN3 paper with Husky printer and YOC/YOP IH ink sets. The printing mode is Photo/Glossy, 4800 dpi. After overnight, the gloss and differential gloss are measured. The results are given in Table 3 below. The differential gloss is very poor.

### Example 7

A standard gloss test file is printed on DN3 paper with Husky printer and YOC/YOP IH ink sets. The printing mode is Photo/Glossy, 4800 dpi. Immediately after printing, the sheet is printed with a P-6250 printer, all chambers of color and photo cartridges filled with FM02-06 (5% Joncryl 678) colorless ink. The print file is a solid block of black. After overnight, the gloss and differential gloss are measured. The results are given in Table 3 below. The differential gloss is improved.

### Example 8

A standard gloss test file is printed on DN3 paper with Husky printer and YOC/YOP IH ink sets. The printing mode is Photo/Glossy, 4800 dpi. Immediately after printing, the sheet is printed with a P-6250 printer, all chambers of color and photo cartridges filled with FM02-06 (5% Joncryl 678) colorless ink. The print file is a solid block of black, with 70% gray scale. After overnight, the gloss and differential gloss are measured. The results are given in Table 3 below. The differential gloss is improved.

### Example 9

A standard gloss test file is printed on DN3 paper with Husky printer and YOC/YOP IH ink sets. The printing mode is Photo/Glossy, 4800 dpi, immediately after printing, the sheet is printed with a P-6250 printer, all chambers of color and photo cartridges filled with FM01-06 (4% Mowiol 3-83) colorless ink. The print file is a solid block of black. After overnight, the gloss and differential gloss are measured. The results are given in Table 3 below. The differential gloss is improved.

TABLE 3

| | Comparative | | | |
|---|---|---|---|---|
| | Example 2 | Example 7 | Example 8 | Example 9 |
| Overcoat | NO | FM02-06 | FM01-06 | FM02-06, |
| | | 5% Joncryl | 4% PVA | 70% of |
| | | 678 | | Example 7 |
| 20° Gloss | 39 | 50 | 33 | 35 |
| 20° Diff | 43 | 25 | 22 | 18 |
| Gloss | | | | |
| 60° Gloss | 80 | 89 | 79 | 82 |
| 60° Diff | 18 | 10 | 7 | 6 |
| Gloss | | | | |

### Effect of Overcoats on Gloss and Differential Gloss

### Gamut, L*min, and Tints

### Comparative Example 3

A standard gamut test file is printed on DN3 paper with Husky printer and YOC/YOP IH ink sets. The printing mode is Photo/Glossy, 4800 dpi. After overnight, the gamut, L*min, and tints are measured. The results are given in Table 4 below.

### Example 10

A standard gamut test file is printed on DN3 paper with Husky printer and YOC/YOP IH ink sets. The printing mode is Photo/Glossy, 4800 dpi. Immediately after printing, the sheet is printed with a P-6250 printer, all chambers of color and photo cartridges filled with FM02-06 (5% Joncryl 678) colorless ink. The print file is a solid block of black, with 70% gray scale. After overnight, the Gamut, L*min, and tints are measured. The results are given in Table 4 below. No major difference from Comparative Example 3.

### Example 11

A standard gamut test file is printed in DN3 paper with Husky printer And YOC/YOP IH ink sets. The print mode is Photo/Glossy, 4800 dpi. Immediately after printing, the sheet is printed with a P-6250 printer, all chambers Of color and photo cartridges filled with FM02-06 (5% Joncryl 678) colorless ink. The print file is a solid block of black, with 30% gray scale. After overnight, the Gamut, L*min, and tints are measured. The results are given in Table 4 below. No major difference from Comparative Example 3.

### Example 12

A standard gamut test file is printed on DN3 paper with Husky printer And YOC/YOP IH ink sets. The printing mode is Photo/Glossy, 4800 dpi. Immediately after printing, the sheet is printed with a P-6250 printers, all chambers Of color and photo cartridges filled with FM01-06 (4% Mowiol 3-83) colorless ink. The print file is a solid block of black, with 30% gray scale. After overnight, the Gamut, L*min, and tins are measured. The results are given in Table 4 below. No major difference from Comparative Example 3.

TABLE 4

| | Comparative | Example | | |
|---|---|---|---|---|
| | Example 3 | 10 | Example 11 | Example 12 |
| Overcoat | NO | FM02-06 | FM02-06 | FM01-06 |
| | | Joncryl | Joncryl 678 | PVA |
| | | 678 | Half of Ex. 10 | |
| Tint | | | | |
| L* | 93.97 | 92.73 | 93.97 | 93.93 |
| a* | −0.05 | 0.10 | 0.07 | −0.06 |
| b* | −4.91 | −5.35 | −5.04 | −4.84 |
| Gamut | | | | |
| Husky | 489 | 519 | 521 | 486 |
| Minimum L* | | | | |
| Husky | 6.6 | 6.1 | 6.02 | 6.36 |

### Effects of Overcoats and Gamut, L*min and Tints

While this invention has been described with respect to embodiments of the invention, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A method for improving the printing properties of pigmented links on glossy media, comprising:
a) printing an inkjet ink from an ink cartridge onto a glossy printing medium to form printed images; and
b) applying a thin coating comprising at least one ingredient selected from the group consisting of a low molecular weight water-soluble polymers, a polymer emulsion, a polymer dispersion, and mixtures thereof on to the printed images.

2. The method of claim 1 wherein said low molecular weight water-soluble polymer is selected from the group consisting of polyvinyl alcohol, acrylate polymer, and mixtures thereof.

3. The method of claim 1 wherein said polymer emulsion is an acrylate latex emulsion and said polymer dispersion is a polyurethane dispersion.

4. The method of claim 1 wherein said thin coating in step b) is applied by a jetting process through at least one chamber of the ink cartridge.

5. The method of claim 2 wherein said polyvinyl alcohol is partially hydrolyzed.

6. The method of claim 2 wherein and acrylate polymer is comprised of water solubilized copolymers or styrene, alpha methylstyrene, and acrylic acid.

7. The method of claim 1 where said thin coating comprises at least one ingredient selected from the group consisting of defoamers, biocides, hardeners and crosslinkers, pigment, UV/light stabilizers, buffers, slip agents, pH control compounds, and mixtures thereof.

8. The method of claim 1 wherein said thin coating comprises a blend of low molecular water soluble polymers.

9. The method of claim 1 where said thin coating comprises a blend of polymers dispersion and a polymer emulsion.

10. The method of claim 1 where said thin coating comprises a blend of low molecular water soluble polymers and polymer emulsion or polymer dispersion.

11. The method of claim 1 of wherein the coating thickness of the thin coating is from about 0.1 μm to about 20 μm.

12. A print media product comprising:
a) a glossy printing medium having printed images therein; and
b) a thin coating on top of the glossy printing medium,
wherein said thin coating comprises at least one ingredient selected from the group consisting of a low molecular weight water-soluble polymer, a polymer emulsion, a polymer dispersion and mixtures thereof, on to the printed images.

13. The print media product of claim 12 wherein said low molecular weight water-soluble polymer is selected from the group consisting of polyvinyl alcohol, acrylate polymer, and mixtures thereof.

14. The print media product of claim 13 wherein said polyvinyl alcohol is partially hydrolyzed and said acrylate polymer is comprised of water solubilized copolymers of styrene, alpha methylstyrene, and acrylic acid.

15. The print media product of claim 12 wherein said a polymer emulsion is an acrylate latex emulsion and said polymer dispersion is a polyurethane dispersion.

16. The print media product of claim 12 wherein said thin coating comprises at least one ingredient selected from the group consisting of defoamers, biocides, hardeners and crosslinkers, pigment, UV/light stabilizers, buffers, slip agents, pH control compounds, and mixtures thereof.

17. The print media product of claim 12 wherein said thin coating comprises blend of low molecular water soluble polymers or a blend of polymer dispersion and emulsion.

18. The print media product of claim 12 wherein said thin coating comprises blend of low molecular water soluble polymers and a blend of polymer emulsion or dispersion.

19. The print media product of claim 12 of wherein the coating thickness of the thin coating is from and about 0.1 μm to about 20 μm.

20. The print media product of claim 12 wherein said glossy printing medium is a polymer-based photo paper.
